(19) United States
(12) Patent Application Publication
(10) Pub. No.: US 2025/0096291 A1
(43) Pub. Date: Mar. 20, 2025

(54) Method and Device of Controlling Drain Valve in Fuel Cell, Controller, Fuel Cell System, and Medium

(71) Applicant: Robert Bosch GmbH, Stuttgart (DE)

(72) Inventors: Ren Dong, Wuxi (CN); Wei Chen, Wuxi (CN); Bo Wei, Wuxi (CN); Yiming Song, Shanghai (CN)

(21) Appl. No.: 18/827,998

(22) Filed: Sep. 9, 2024

(30) Foreign Application Priority Data
Sep. 19, 2023 (CN) 2023 1121 1372.4

(51) Int. Cl. H01M 8/04746; H01M 8/0438; H01M 8/04537

(52) U.S. Cl. CPC H01M 8/04761; H01M 8/04425; H01M 8/04567; H01M 8/04597

(57) ABSTRACT

A method and device of controlling a drain valve of a fuel cell, a controller, a fuel cell system, and a medium is disclosed. The method includes (i) acquiring a permeate water mass flow rate from a cathode to an anode of the fuel cell system and a separation efficiency of a water-gas separator in the fuel cell system, (ii) determining a water mass flow rate level of water passing through a hydrogen circulating pump based on a drive current of the hydrogen circulating pump in the fuel cell system, (iii) determining a circulating water mass flow rate passing through the hydrogen circulating pump based on the permeate water mass flow rate, the separation efficiency, and the water mass flow rate level, and (iv) controlling the drain valve in the fuel cell system based on the circulating water mass flow rate. Solutions provided by the examples of the present disclosure are capable of more precisely controlling a frequency and duration of opening the drain valve while saving costs, thereby being capable of improving the safety and performance of the fuel cell system.

This application claims priority under 35 U.S.C. § 119 to patent application no. CN 2023 1121 1372.4, filed on Sep. 19, 2023 in China, the disclosure of which is incorporated herein by reference in its entirety.

The present disclosure relates to the field of fuel cell systems, and more particularly relates to a method and device of controlling a drain valve in a fuel cell system, a controller, the fuel cell system, and a medium.

### BACKGROUND

A fuel cell system is a device that generates electrical energy through a chemical reaction of hydrogen with oxygen. In the chemical reaction, hydrogen and oxygen are combined to generate water, and the generated water is one of main by-products of generation of the electrical energy. Water vapor and liquid water generated in the fuel cell system need to be discharged to avoid system performance decline and even system damage caused by water accumulation. A water-gas separator is located at a rear end of a galvanic pile of the fuel cell system and is used to separate moisture mixed in gas such as hydrogen discharged at the anode outlet from the gas. In order to avoid liquid water entrainment, a gas-liquid separator is required to have a strong water-gas separation efficiency.

The water that is captured by the water-gas separator may be controlled by a drain valve located at the rear end of the water-gas separator. When the drain valve is opened, the water may flow to a drain device, thereby being drained out of a vehicle; and when the drain valve is closed, the water may be stored in the water-gas separator. The drain valve plays an important role in protecting an apparatus, maintaining system performance and discharging moisture generated in the fuel cell system, thereby ensuring that the system is capable of operating stably and generating the required electrical energy. How to accurately control the frequency and duration of opening the drain valve is a problem that needs to be solved.

### SUMMARY

Embodiments of the present disclosure provide a method and device for controlling a drain valve in a fuel cell system, a controller, the fuel cell system, and a medium. In the examples of the present disclosure, a permeate water mass flow rate of moisture that permeates from a cathode of a galvanic pile to an anode through a proton exchange membrane in the fuel cell system, as well as an estimated separation efficiency of the water-gas separator may be acquired. However, it is not accurate to calculate a water mass flow rate of moisture separated by the water-gas separator through the permeate water mass flow rate and the estimated separation efficiency of the water-gas separator, so the examples of the present disclosure are also capable of estimating a water mass flow rate level of the moisture passing through the hydrogen circulating pump based on the drive current of the hydrogen circulating pump in the fuel cell system, wherein the higher the water mass flow rate level, the greater the water mass flow rate of the moisture passing through the hydrogen circulating pump. The examples of the present disclosure may then more accurately determine a circulating water mass flow rate passing through the hydrogen circulating pump based on the permeate water mass flow rate, the separation efficiency of the water-gas separator and the water mass flow rate level of moisture passing through the hydrogen circulating pump. Therefore, the examples of the present disclosure may control the frequency and duration of opening the drain valve based on the circulating water mass flow rate. In this way, the opening of the drain valve can be controlled based on more accurate data without the use of additional sensors, enabling the provision of more accurate data for determining, for example, the frequency and duration of opening the drain valve for decision making while reducing the cost of the fuel cell system, thereby being capable of determining a more suitable opening frequency and opening duration of the drain valve and improving the safety and performance of the fuel cell system.

In a first aspect of the present disclosure, a method for controlling a drain valve in a fuel cell system is provided. The method comprises: acquiring a permeate water mass flow rate from a cathode to an anode of the fuel cell system and a separation efficiency of a water-gas separator in the fuel cell system. The method further comprises: determining a water mass flow rate level of water passing through a hydrogen circulating pump based on a drive current of the hydrogen circulating pump in the fuel cell system. The method further comprises: determining a circulating water mass flow rate passing through the hydrogen circulating pump based on the permeate water mass flow rate, the separation efficiency, and the water mass flow rate level. Furthermore, the method further comprises: controlling a drain valve in the fuel cell system based on the circulating water mass flow rate.

In a second aspect of the present disclosure, a device is provided. The device comprises a permeate water flow rate acquiring unit configured to acquire a permeate water mass flow rate from a cathode to an anode of the fuel cell system and a separation efficiency of a water-gas separator in the fuel cell system. The device further comprises a circulating water level determining unit configured to determine a water mass flow rate level of water passing through the hydrogen circulating pump based on a drive current of a hydrogen circulating pump in the fuel cell system. The device further comprises a circulating water flow rate determining unit configured to determine a circulating water mass flow rate passing through the hydrogen circulating pump based on the permeate water mass flow rate, the separation efficiency, and the water mass flow rate level. Furthermore, the device further comprises a drain valve control unit configured to control the drain valve in the fuel cell system based on the circulating water mass flow rate.

In a third aspect of the present disclosure, a controller is provided. The controller comprises one or more processors; and a storage device for storing one or more programs, which, when the one or more programs are executed by the one or more processors, causes the one or more processors to implement a method for controlling a drain valve in a fuel cell system. The method comprises: acquiring a permeate water mass flow rate from a cathode to an anode of the fuel cell system and a separation efficiency of a water-gas separator in the fuel cell system. The method further comprises: determining a water mass flow rate level of water passing through a hydrogen circulating pump based on a drive current of the hydrogen circulating pump in the fuel cell system. The method further comprises: determining a circulating water mass flow rate passing through the hydrogen circulating pump based on the permeate water mass flow rate, the separation efficiency, and the water mass flow rate level. Furthermore, the method further comprises: controlling the drain valve in the fuel cell system based on the circulating water mass flow rate.

In a fourth aspect of the present disclosure, a fuel cell system is provided. The fuel cell system comprises a galvanic pile; a water-gas separator located in a first channel connected to an anode outlet of the galvanic pile; a drain valve located in a second channel connected to the water-gas separator; a hydrogen circulating pump located in a third channel connected to an anode inlet of the galvanic pile; and a controller configured to: acquire a permeate water mass flow rate from a cathode to an anode and a separation efficiency of the water-gas separator; determine a water mass flow rate level of water passing through a hydrogen circulating pump based on a drive current of the hydrogen circulating pump; determine a circulating water mass flow rate passing through the hydrogen circulating pump based on the permeate water mass flow rate, the separation efficiency, and the water mass flow rate level; and control the drain valve based on the circulating water mass flow rate.

According to a fifth aspect of the present disclosure, a computer-readable storage medium is provided. The computer-readable storage medium has computer-executable instructions stored thereon, wherein the computer-executable instructions are executed by a processor to implement the method provided according to the first aspect of the present disclosure.

It will be understood that the description in the summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

Above and other features, advantages and aspects of various examples of the present disclosure will become more apparent in combination with the accompanying drawings and with reference to the following detailed description. In the accompanying drawings, same or similar accompanying drawing annotations represent same or similar elements, wherein:

FIG. 1 shows a schematic diagram of an example environment in which a plurality of examples of the present disclosure may be implemented;

FIG. 2 shows a flow chart of a method for controlling a drain valve in a fuel cell system according to some examples of the present disclosure;

FIG. 3 shows a schematic diagram of an example process for determining a water mass flow rate level of water passing through a hydrogen circulating pump based on a drive current of the hydrogen circulating pump in the fuel cell system according to some typical examples of the present disclosure;

FIG. 4 shows a schematic diagram of another example process for determining the water mass flow rate level of water passing through the hydrogen circulating pump based on the drive current of the hydrogen circulating pump in the fuel cell system according to some typical examples of the present disclosure;

FIG. 5 shows a schematic diagram of an example process for determining a circulating water mass flow rate and a separated water mass flow rate upon activation of the fuel cell system according to some examples of the present disclosure;

FIG. 6 shows a schematic diagram of an example process for determining the circulating water mass flow rate and the separated water mass flow rate upon normal operation of the fuel cell system according to some examples of the present disclosure;

FIG. 7 shows a schematic diagram of another example process for determining the circulating water mass flow rate and the separated water mass flow rate upon normal operation of the fuel cell system according to some examples of the present disclosure;

FIG. 8 shows a block diagram of a device for controlling the drain valve in the fuel cell system according to some examples of the present disclosure; and

FIG. 9 shows a block diagram of an apparatus that can implement a plurality of examples of the present disclosure.

### DETAILED DESCRIPTION

The examples of the present disclosure will be described in further detail below with reference to the accompanying drawings. Although certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It will be understood that the accompanying drawings and examples of the present disclosure are for exemplary purposes only and are not intended to limit the scope of protection of the present disclosure, and the examples of the present disclosure that are described below with reference to the accompanying drawings are for illustrative purposes only.

A fuel cell system generates electrical energy through a chemical reaction of hydrogen with oxygen. The fuel cell system comprises an anode and a cathode, hydrogen may be introduced at the anode, and oxygen may be introduced at the cathode. A proton exchange membrane is a semi-permeable membrane located between the anode and the cathode, which is used to conduct protons and isolate reactants located at the anode and the cathode. In an electrochemical reaction, the hydrogen at the anode binds to the oxygen at the cathode, water is generated at the cathode, and the generated water is one of main by-products of generation of electrical energy. However, part of water at the cathode may permeate to the anode through a proton exchange membrane, so there is a need to discharge the water at the anode in time to prevent damage to the galvanic pile due to water inundation at the anode.

The fuel cell system comprises a water-gas separator, water discharged from the anode (e.g., water vapor) passes through the water-gas separator, one part of the water may be captured by the water-gas separator, and the other part of the water passes through the water-gas separator and is circulated back to the anode under the action of the hydrogen circulating pump. The fuel cell system further comprises a drain valve, and when the drain valve is opened, the water that is captured by the water-gas separator can flow to an exhaust device and be drained out of the vehicle through the exhaust device. However, when the drain valve is opened, part of hydrogen to the hydrogen circulating pump may be mixed with water to be discharged out of the vehicle together. If the frequency of opening the drain valve is very high or the duration of opening the drain valve is very long, an amount of hydrogen discharged out of the vehicle along with the water also increases, which can easily result in the amount of hydrogen discharged from the exhaust device not complying with safety regulations.

In order to determine the appropriate frequency and duration of opening the drain valve, the amount of water at the water-gas separator requires to be accurately monitored. In some conventional solutions, a voltage sensor may be arranged inside the galvanic pile of the fuel cell system for measuring a monolithic voltage of the galvanic pile. Because a high or low monolithic voltage of the galvanic pile may indicate a greater or less amount of water inside the galvanic pile, the amount of water at the anode can be monitored by measuring the monolithic voltage of the galvanic pile using the voltage sensor, thereby controlling the frequency and duration of opening the drain valve. However, the voltage sensor is very expensive, and the use of the voltage sensor to monitor the amount of water at the anode increases the cost of the fuel cell system.

To this end, the examples of the present disclosure provide a solution for controlling a drain valve in a fuel cell system. In the examples of the present disclosure, a permeate water mass flow rate of moisture that permeates from a cathode of a galvanic pile to an anode through a proton exchange membrane in the fuel cell system, as well as an estimated separation efficiency of the water-gas separator may be acquired. The examples of the present disclosure may then estimate a water mass flow rate level of moisture passing through a hydrogen circulating pump based on a drive current of the hydrogen circulating pump in the fuel battery system, and the higher the water mass flow rate level, the greater the water mass flow rate of moisture passing through the hydrogen circulating pump. The examples of the present disclosure may then more accurately determine a circulating water mass flow rate passing through the hydrogen circulating pump based on the permeate water mass flow rate, the separation efficiency of the water-gas separator and the water mass flow rate level of moisture passing through the hydrogen circulating pump. Therefore, the examples of the present disclosure may control the drain valve based on the circulating water mass flow rate, for example, control the frequency and duration of opening the drain valve.

In this way, the opening of the drain valve can be controlled based on more accurate data without the use of additional sensors, enabling the provision of more accurate data for determining the opening frequency and the opening duration of the drain valve for decision making while reducing the cost of the fuel cell system, thereby being capable of determining a more suitable opening frequency and opening duration of the drain valve and improving the safety and performance of the fuel cell system.

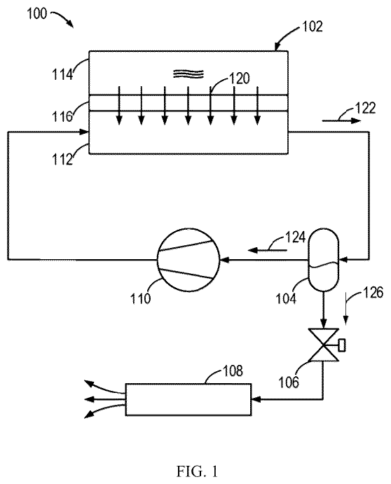

FIG. 1 shows a schematic diagram of an example environment 100 in which a plurality of typical examples of the present disclosure may be implemented. As shown in FIG. 1, the environment 100 comprises a galvanic pile 102, a water-gas separator 104, a drain valve 106, an exhaust device 108 and a hydrogen circulating pump 110. The galvanic pile 102 comprises an anode 112, a cathode 114 and a proton exchange membrane 116. In the environment 100 as shown, hydrogen enters the anode 112 of the galvanic pile 102, oxygen enters the cathode 114 of the galvanic pile 102, the hydrogen and the oxygen make an electrochemical reaction, and water is generated at the cathode 114. Typically, most of the generated water may be discharged out of the cathode 114 through an air outlet; however, a water concentration at the cathode 114 is higher, and a water concentration difference is formed on both sides of the proton exchange membrane 116, so that part of water diffuses to the anode 112 through the proton exchange membrane 116, and the water diffusing to the anode 112 is shown in FIG. 1 as permeable water 120. When the permeable water 120 is discharged from an outlet of the anode, the water may pass through the water-gas separator 104, and water which is successfully captured by the water-gas separator 104 is shown in FIG. 1 as separated water 126. Water which is not captured by the water-gas separator 104 is recycled back to the anode 112 of the galvanic pile 102 under the action of the hydrogen circulating pump 110, and the water is shown in FIG. 1 as circulating water 124. Since the circulating water 124 will merge with the permeate water 120 at the anode 112 to be then discharged out of the anode 112, water at the outlet of anode 112 will include the permeate water 120 and the circulating water 124, and the water is shown in FIG. 1 as anode outlet water 122.

As shown in FIG. 1, in the environment 100, the separated water 126 that is successfully captured by the water-gas separator 104 may be stored in the water-gas separator 104, and the water-gas separator 104 is connected or integrated with the electrically controlled drain valve 106. The frequency and duration of opening the drain valve 106 may be controlled by a control unit of the fuel cell system. When the drain valve 106 is opened, the water stored in the water-gas separator may flow to the exhaust device 108 and be discharged out of the vehicle by the exhaust device 108. However, since the water-gas separator 104 is uncapable of completely separate hydrogen from moisture, part of hydrogen will be discharged out of the vehicle along with water when the drain valve 106 is opened. If the frequency of opening the drain valve is low or the duration of opening the drain valve 106 is short, it may cause more liquid water entering the galvanic pile 102, thereby causing flooding and damage to the galvanic pile 102 and affecting the normal operation of the environment 100. If the frequency of opening the drain valve is high or the duration of opening the drain valve 106 is long, it may cause an increase in hydrogen discharged out of the vehicle along with water, thereby violating safety standards.

In the environment 100 shown in FIG. 1, data such as the drive current of the hydrogen circulating pump 110 can be monitored. The greater the water mass flow rate of the circulating water 124, the greater the resistance borne by an impeller of the hydrogen circulating pump 110, and an upward offset and an oscillation will occur to the drive current of the hydrogen circulating pump. Thus, the water mass flow rate level of the circulating water 124 may be estimated based on the drive current of the hydrogen circulating pump 110, e.g., the higher the water mass flow rate level, the greater the water mass flow rate of the circulating water 124. The water mass flow rate of the circulating water 124 passing through the hydrogen circulating pump 110 may then be corrected based on the water mass flow rate level of the circulating water 124. In this way, the opening of the drain valve 106 may be controlled based on more accurate data without the use of additional sensors, enabling more accurate control over the drain valve 106 while reducing the cost of the fuel cell system.

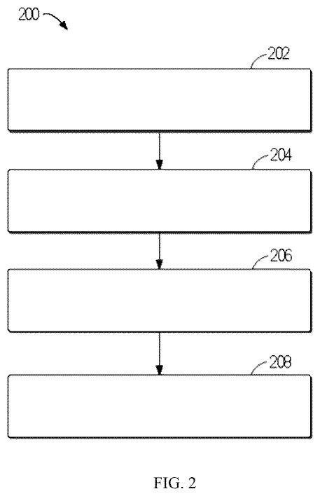

FIG. 2 shows a flow chart of a method 200 for controlling a drain valve in a fuel cell system according to some examples of the present disclosure. The method 200 may be performed, for example, by a controller or a control unit in the fuel cell system. As shown in FIG. 2, in block 202, the method 200 acquires a permeate water mass flow rate from a cathode to an anode of the fuel cell system and a separation efficiency of a water-gas separator in the fuel cell system. For example, in the environment 100 shown in FIG. 1, the method 200 may acquire the permeate water mass flow rate 120 from the cathode 114 to the anode 112. In addition, the method 200 may also acquire the separation efficiency of the water-gas separator 104, and the separation efficiency may be a predefined value or a value estimated according to some metric values. For example, the separation efficiency may be predefined as 60%, 80%, or 100%, etc., or the separation efficiency may be evaluated based on the metric values collected from the environment 100, and the separation efficiency is updated by re-collecting these metric values every once in a while; and the present disclosure does not define a method of estimating the separation efficiency.

In block 204, the method 200 determines a water mass flow rate level of water passing through the hydrogen circulating pump based on a drive current of the hydrogen circulating pump in the fuel cell system. For example, in the environment 100 shown in FIG. 1, the circulating water mass flow rate 124 affects the operation of the hydrogen circulating pump 110 as it passes through the hydrogen circulating pump 110. For example, the hydrogen circulating pump 110 may internally comprises a motor and an impeller, and the impeller is driven by the motor to rotate to operate the hydrogen circulating pump 110; when the circulating water mass flow rate 124 (e.g., in the form of water vapor) passing through the hydrogen circulating pump 110 increases, the resistance encountered by the impeller increases, such that phenomena of upward offset and oscillation occur to the drive current of the hydrogen circulating pump 110; and the larger a value of the circulating water mass flow rate 124, the more significant the phenomena of upward offset and oscillation of the drive current. Accordingly, the water mass flow rate level for the circulating water mass flow rate 124 may be determined based on the drive current of the hydrogen circulating pump 110.

In block 206, the method 200 determines the circulating water mass flow rate passing through the hydrogen circulating pump based on the permeate water mass flow rate, the separation efficiency of the water-gas separator and the water mass flow rate level. For example, in the environment 100 shown in FIG. 1, the circulating water mass flow rate 124 may be determined based on the permeate water mass flow rate 120 that may permeate from the cathode 114 to the anode 112 of the galvanic pile 102, the pre-defined or estimated separation efficiency of the water-gas separator 104 and the water mass flow rate level of the circulating water mass flow rate 124 determined based on the drive current of the hydrogen circulating pump 110.

In block 208, the method 200 controls the drain valve in the fuel cell system based on the circulating water mass flow rate. For example, in the environment 100 shown in FIG. 1, the separated water mass flow rate 126 that is captured by the water-gas separator 104 may be determined based on the circulating water mass flow rate 124, thereby being capable of determining the amount of water stored in the water-gas separator 104 over a period of time when the drain valve 106 is closed and controlling the frequency and duration of opening the drain valve 106 based on the amount of water stored. In this way, the drain valve 106 is capable of being opened when more water is stored, so that the water is capable of being discharged through the exhaust device 108. Furthermore, the drain valve 106 is capable of being closed when the amount of water stored is less, so that hydrogen is prevented from being excessively discharged into the external environment.

In this way, the circulating water mass flow rate 124 determined based on the permeate water mass flow rate 120 and the separation efficiency of the water-gas separator 104 can be corrected by determining the water mass flow rate level of the circulating water mass flow rate 124, thereby being capable of making the determined circulating water mass flow rate 124 more accurate. Since the determined circulating water mass flow rate 124 is more accurate, the drain valve 126 may be controlled more precisely, for example, the frequency and duration of opening the drain valve 126 may be controlled more precisely, thereby being capable of improving the safety and performance of the fuel cell system. In addition, this manner avoids the use of additional sensors to monitor data, thereby being capable of reducing the cost of the fuel cell system and the vehicle.

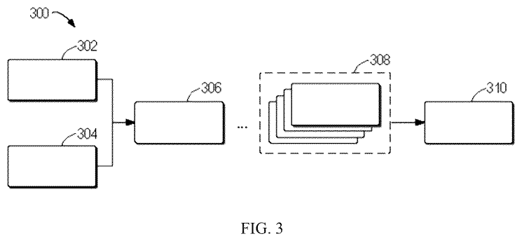

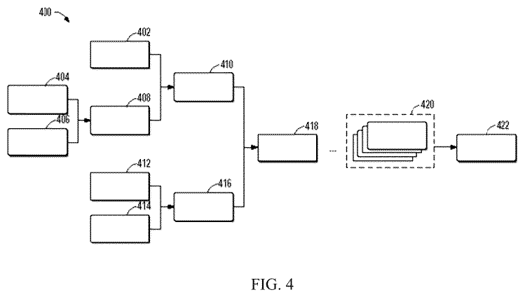

As noted above, when water that is not captured by the water-gas separator 104 passes through the hydrogen circulating pump 110, the impeller of the hydrogen circulating pump 110 encounters resistance, so that phenomena of upward offset and oscillation occur to the drive current of the hydrogen circulating pump 110; and the greater the water mass flow rate passing through the hydrogen circulating pump 110, the more significant the phenomena of upward offset and oscillation of the drive current. Accordingly, the water mass flow rate level of the circulating water mass flow rate 124 may be determined based on the drive current of the hydrogen circulating pump 110. FIG. 3 to FIG. 4 show schematic diagrams of an example process 300 and an example process 400 for determining a water mass flow rate level of a circulating water mass flow rate passing through a hydrogen circulating pump based on a drive current of the hydrogen circulating pump in a fuel cell system according to some examples of the present disclosure.

In the process 300 shown in FIG. 3, the drive current 302 of the hydrogen circulating pump (e.g., the hydrogen circulating pump 110 in FIG. 1) may be obtained. Further, the process 300 may also determine a reference value 304 for the drive current, and the reference value 304 is used to determine an extent to which an upward offset of the drive current 302 occurs. The reference value 304 may be a predefined value or may be a value determined based on other metric values in the fuel cell system. In the example shown by the process 300, the reference value 304 may be, for example, a predefined value. The process 300 may then determine an offset value 306 based on the drive current 302 and the reference value 304, and the offset value 306 indicates the extent to which the drive current 302 exceeds the reference value 304. In some examples, a difference between the drive current 302 and the reference value 304 may be determined; if the difference is greater than zero, the difference is determined to be the offset value 306; and if the difference is less than or equal to zero, the offset value 306 is determined to be zero.

As shown in FIG. 3, similar to the process of determining the offset value 306, for a plurality of moments over a period of time, the process 300 may determine offset values of a plurality of drive currents for a plurality of moments. The process 300 may then determine a total offset value 308 of the drive currents within the period of time based on the offset values of the plurality of drive currents. The process 300 may then determine a water mass flow rate level 310 of the circulating water mass flow rate passing through the hydrogen circulating pump based on the total offset value 308. In some examples, the process 300 may predetermine a mapping relationship between the total offset value 308 and the water mass flow rate level 310, for example, a range 1 of the total offset value may be mapped to a level 1, a range 2 of the total offset value may be mapped to a level 2, . . . , a range N of the total offset value may be mapped to a level N. The process 300 may then determine a water mass flow rate level 310 corresponding to the total offset value 308 based on the mapping relationship.

In this way, the water mass flow rate level can be determined based on the principle that the greater the water mass flow rate passing through the hydrogen circulating pump, the greater the extent of the upward offset and oscillation of the drive current of the hydrogen circulating pump; the water mass flow rate level is capable of qualitatively indicating that the water mass flow rate passing through the hydrogen circulating pump is greater or smaller, thereby being capable of providing additional information for determining the circulating water mass flow rate passing through the hydrogen circulating pump (i.e., the water mass flow rate of water that is not captured by the water-gas separator), so that the accuracy of the determined circulating water mass flow rate is capable of being improved.

In some examples, in order to determine the total offset value of the drive current (i.e., a value associated with the upward offset and oscillation of the drive current), the total offset value may be determined based on the drive current, drive voltage, reference voltage and rotating speed of the hydrogen circulating pump and the current of the galvanic pile. In some examples, a reference value for the drive current may be determined based on the rotating speed of the hydrogen circulating pump and the current of the galvanic pile, and then the total offset value may be determined based on the drive current and the reference value.

FIG. 4 shows a schematic diagram of another example process 400 for determining a water mass flow rate level of water passing through the hydrogen circulating pump based on the drive current of the hydrogen circulating pump in the fuel cell system according to some examples of the present disclosure. As shown in FIG. 4, the process 400 may acquire a drive current 402 of a hydrogen circulating pump (e.g., hydrogen circulating pump 110 in FIG. 1). However, when drive voltages of the hydrogen circulating pump are different, the comparison of the drive currents may be affected, so that the drive currents 402 may be corrected to eliminate the effects of different drive voltages on the comparison process of the drive currents. As shown in FIG. 4, the process 400 may acquire the drive voltage 404 and the reference voltage 406 of the hydrogen circulating pump and then determine a normalized voltage 408 based on the drive voltage 404 and the reference voltage 406. For example, in some examples, a correction ratio 408 (may also be referred to as the normalized voltage) may be determined by determining a ratio of the drive voltage 404 to the reference voltage 406. The process 400 may then determine a correction current 410 (may also be referred to as relative power) based on the drive current 402 and the correction ratio 408. For example, the process 400 can determine the correction current 410 by determining a product of the drive current 402 and the correction ratio 408.

As shown in FIG. 4, the process 400 may also determine a reference value 416, and the reference value 416 is used to determine an extent to which an upward offset occurs to the correction current 410. In the process 400 shown in FIG. 4, a current 412 of the galvanic pile (e.g., the galvanic pile 102 in FIG. 1) and the rotating speed 414 of the hydrogen circulating pump may be acquired, and the reference value 416 may be then determined based on the current 412 of the galvanic pile and the rotating speed 414 of the hydrogen circulating pump. In some examples, a mapping relationship between pairing of the current of the galvanic pile and the rotating speed of the hydrogen circulating pump to the reference value 416 may be predetermined, and the reference value 416 may be determined based on the current of the galvanic pile 412, the rotating speed of the hydrogen circulating pump 414 and the mapping relationship. After determining the correction current 410 and the reference value 416, the offset value 418 may be determined based on the correction current 410 and the reference value 416, and the reference value 418 indicates an extent to which the correction current 410 exceeds the reference value 416. In some examples, a difference between the correction current 410 and the reference value 416 may be determined; if the difference is greater than zero, the difference is determined to be the offset value 418; and if the difference is less than or equal to zero, the offset value 418 is determined to be zero.

As shown in FIG. 4, similar to the process of determining the offset value 418, for a plurality of moments over a period of time, the process 400 may determine a total offset value 420 of the correction current over a period of time for the offset values of a plurality of correction currents for the plurality of moments. The process 400 may then determine the water mass flow rate level 422 of the circulating water mass flow rate passing through the hydrogen circulating pump based on the total offset value 420. In some examples, the process 300 may predetermine a mapping relationship between the total offset value 420 and the water mass flow rate level 422, and then determine a water mass flow rate level 422 corresponding to the total offset value 420 based on the mapping relationship. In some examples, an offset power value may be determined based on the total offset value 420 and the reference voltage 406 of the hydrogen circulating pump; and the process 300 may predetermine the mapping relationship between the offset power value to the water mass flow rate level 422, and then determine the water mass flow rate level 422 corresponding to the offset power value based on the mapping relationship.

In this way, the influence of different drive voltages on the comparison process of the drive currents can be reduced by correcting the drive current of the hydrogen circulating pump, thereby being capable of improving the accuracy of the determined water mass flow rate level. Moreover, by determining the reference value based on the current of the galvanic pile and the rotating speed of the hydrogen circulating pump, the reference value can be dynamically determined, thereby being capable of improving the accuracy of the reference value, and further improving the accuracy of the determined water mass flow rate level.

After determining the water mass flow rate level of the circulating water mass flow rate passing through the hydrogen circulating pump, the circulating water mass flow rate and the separated water mass flow rate may be determined based on the water mass flow rate level, the permeate water mass flow rate that diffuses from the cathode to the anode of the galvanic pile and the separation efficiency of the water-gas separator. In some examples, in order to determine the circulating water mass flow rate passing through the hydrogen circulating pump, a historical circulating water mass flow rate passing through the hydrogen circulating pump at a first moment may be obtained, and then the water mass flow rate at the anode outlet of the galvanic pile (also referred to as the first water mass flow rate) is determined based on the permeate water mass flow rate and the historical circulating water mass flow rate. The circulating water mass flow rate may then be determined based on the water mass flow rate at the anode outlet, the separation efficiency of the water-gas separator and the water mass flow rate level. In some examples, the circulating water mass flow rate to be corrected may be determined based on the water mass flow rate at the anode outlet and the separation efficiency of the water-gas separator, and the circulating water mass flow rate may then be determined based on the circulating water mass flow rate to be corrected and the water mass flow rate level.

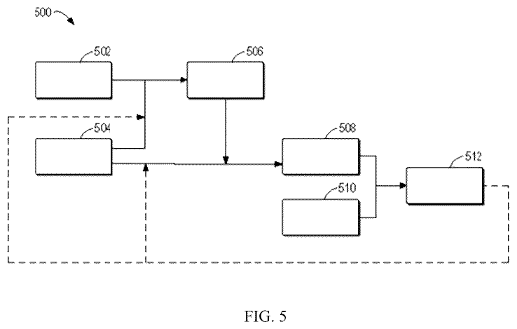

In some examples, the mapping relationship between a plurality of water mass flow rate levels and a plurality of correction parameters may be acquired, and then the correction parameter corresponding to the water mass flow rate level in the plurality of correction parameters may be determined based on the water mass flow rate level and the mapping relationship. The circulating water mass flow rate can then be determined based on the circulating water mass flow rate to be corrected and the correction parameter. In some examples, the permeate water mass flow rate from the cathode to the anode of the fuel cell system (also referred to as the second permeate water mass flow rate) and the separation efficiency (also referred to as a second separation efficiency) of the water-gas separator may be acquired at a second moment, and a separated water mass flow rate separated by the water-gas separator may be then determined based on the circulating water mass flow rate, the permeate water mass flow rate, and the separation efficiency. The drain valve in the fuel cell system may then be controlled based on the separated water mass flow rate. FIG. 5 to FIG. 7 show schematic diagrams of various example processes for determining the circulating water mass flow rate and the separated water mass flow rate at different moments according to some examples of the present disclosure.

FIG. 5 shows a schematic diagram of an example process 500 for determining the circulating water mass flow rate and the separated water mass flow rate upon activation of the fuel cell system according to some examples of the present disclosure. In the environment 100 shown in FIG. 1, upon activation of the fuel cell system, there is no water circulated by the hydrogen circulating pump 110 at the inlet of the anode 112 of the galvanic pile 102 yet, so water at the outlet of the anode 112 of the galvanic pile 102 (i.e., an anode water outlet 122) consists primarily of permeable water 120 that diffuses from the cathode 114 to the anode 112 of the galvanic pile 102. Thus, as shown in FIG. 5, the process 500 may acquire the separation efficiency 502 of the water-gas separator (e.g., the water-gas separator 104 in FIG. 1) and the permeate water mass flow rate 504 that diffuses from the anode to the cathode of the galvanic pile. Then, in one aspect, the process 500 can determine the separated water mass flow rate 506 that is captured by the water-gas separator based on the separation efficiency 502 and the permeate water mass flow rate 504. For example, the process 500 can determine the separated water mass flow rate 506 by determining a product of the permeate water mass flow rate 504 and the separation efficiency 502. In another aspect, the process 500 may determine the circulating water mass flow rate 508 that is not captured by the water-gas separator based on the permeate water mass flow rate 504 and the separated water mass flow rate 506 (for example, the circulating water mass flow rate 508 may be a water mass flow rate of circulating water 124 in FIG. 1). For example, the process 500 can determine the circulating water mass flow rate by determining a difference between the permeate water mass flow rate 504 and the separated water mass flow rate 506. In some examples, the process 500 may also determine the circulating water mass flow rate 508 based on the permeate water mass flow rate 504 and the separation efficiency 502.

Since the accurate separation efficiency 502 cannot be obtained, the determined circulating water mass flow rate 508 may also be inaccurate, and the circulating water mass flow rate 508 may be corrected using the circulating water mass flow rate level determined by the process 300 and the process 400 shown in FIG. 3 and FIG. 4. As shown in FIG. 5, the process 500 may determine a corrected circulating water mass flow rate 512 based on the circulating water mass flow rate 508 and the water mass flow rate level 510, and the water mass flow rate level 510 may be, for example, determined by the process 400 shown in FIG. 4. In some examples, a mapping relationship between the plurality of water mass flow rate levels and the plurality of correction parameters may be obtained, and then the correction parameter corresponding to the water mass flow rate level 510 in the plurality of correction parameters may be determined based on the water mass flow rate level 510 and the mapping relationship. The corrected circulating water mass flow rate 512 may then be determined based on the circulating water mass flow rate to be corrected 508 and the correction parameter. For example, the corrected circulating water mass flow rate level 512 may be determined by determining the product of the circulating water mass flow rate 508 and the correction parameter.

For example, in the environment 100 shown in FIG. 1, after the circulating water 124 that is not captured by the water-gas separator 104 is generated, the water passes through the hydrogen circulating pump 110 to the anode 112 of the galvanic pile 102 and merges with newly generated permeate water that diffuses from the cathode 114 to the anode 112 to be discharged from the outlet of the anode 112. Thus, when the water discharged at the outlet of the anode 112 at the next moment is determined, both the permeate water and the circulating water produced at the previous moment and circulated back to the anode of the galvanic pile need to be considered. Returning to FIG. 5, after the corrected circulating water mass flow rate 512 is determined, it may be used to determine the separated water mass flow rate and the circulating water mass flow rate at the next moment.

By correcting the circulating water mass flow rate 508 using the water mass flow rate level 510, the accuracy of the determined circulating water mass flow rate is capable of being improved, thereby being capable of improving the accuracy of the separated water mass flow rate determined at the next moment. Since the accuracy of the separated water mass flow rate is improved, the frequency and duration of opening the drain valve are capable of being controlled more accurately, thereby being capable of improving the safety and performance of the fuel cell system.

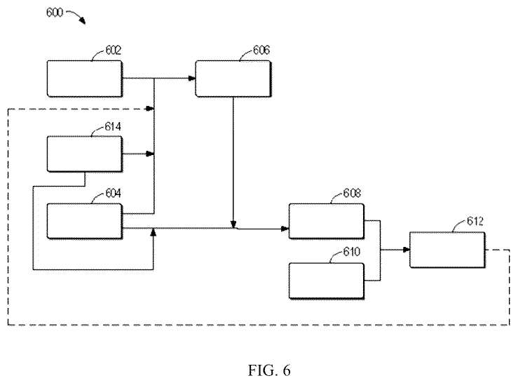

FIG. 6 shows a schematic diagram of an example process 600 for determining the circulating water mass flow rate and the separated water mass flow rate upon normal operation of the fuel cell system according to some examples of the present disclosure. As shown in FIG. 6, the process 600 can acquire the separation efficiency 602 of the hydrogen circulating pump, the permeate water mass flow rate 604 that diffuses from the cathode to the anode of the galvanic pile, and the circulating water mass flow rate 614 (e.g., may be the corrected circulating water mass flow rate 512 in FIG. 5) that is circulated from the hydrogen circulating pump back to the anode of the galvanic pile at the previous moment. In one aspect, the process 600 can determine the separated water mass flow rate 606 based on the separation efficiency 602, the permeate water mass flow rate 604 and the circulating water mass flow rate 614. For example, the process 600 can determine the water mass flow rate at the anode outlet by determining a sum of the permeate water mass flow rate 604 and the circulating water mass flow rate 614, and then the separated water mass flow rate 606 is determined by determining the product of the water mass flow rate at the anode outlet and the separation efficiency 602. In some examples, the separation efficiency 602 of the water-gas separator may be redetermined at each moment.

In another aspect, as shown in FIG. 6, the process 600 can determine the circulating water mass flow rate 608 of the circulating water that is not captured by the water-gas separator at the current moment based on the permeate water mass flow rate 604, the circulating water mass flow rate 614 and the separated water mass flow rate 606. The circulating water that is not captured by the water-gas separator at the current moment is circulated by the hydrogen circulating pump and circulated back to the anode of the galvanic pile at the next moment. Similar to the process 500 shown in FIG. 5, the process 600 can determine the corrected circulating water mass flow rate 612 based on the circulating water mass flow rate 608 and the water mass flow rate level 610, and the corrected circulating water mass flow rate 612 can be used to determine the separated water mass flow rate and the circulating water mass flow rate at the next moment. In some examples, the water mass flow rate level 610 may be redetermined at each moment.

In this way, the separated water mass flow rate at the current moment can be determined using the corrected circulating water mass flow rate determined at the previous moment, thereby being capable of improving the accuracy of the determined separated water mass flow rate that is captured by the water-gas separator. Therefore, the frequency and duration of opening the drain valve are capable of being controlled more accurately, thereby being capable of improving the safety and performance of the fuel cell system.

In some examples, when the separated water mass flow rate that is captured by the water-gas separator is determined, condensed water formed in a flow channel of the galvanic pile due to condensation may be considered. In some examples, the condensed water mass flow rate in the flow channel of the galvanic pile of the fuel cell system may be determined. The separated water mass flow rate may then be determined based on the water mass flow rate (also referred to as the second water mass flow rate) at the anode outlet of the galvanic pile and the condensed water mass flow rate.

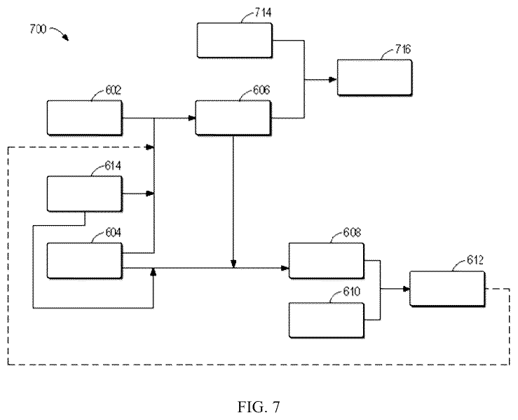

FIG. 7 shows a schematic diagram of another example process 700 for determining the circulating water mass flow rate and the separated water mass flow rate upon normal operation of the fuel cell system according to some examples of the present disclosure; and compared to the process 600 shown in FIG. 6, the process 700 shown in FIG. 7 will consider the condensed water mass flow rate in the flow channel of the galvanic pile when the separated water mass flow rate is captured by the water-gas separator is determined. As shown in FIG. 7, the process 700 can determine the separated water mass flow rate 606 that is captured by the water-gas separator based on the separation efficiency 602 of the water-gas separator, the permeate water mass flow rate 604 and the circulating water mass flow rate 614 that is circulated from the hydrogen circulating pump back to the anode of the galvanic pile at the previous moment. The process 700 may also acquire the condensed water mass flow rate 714 in consideration to the condensed water existing in the flow channel of the galvanic pile of the fuel cell system. The process 700 may then determine a total separated water mass flow rate 716 that is captured by the water-gas separator based on the separated water mass flow rate 606 and the condensed water mass flow rate 714. For example, the process 700 can determine the total separated water mass flow rate 716 by determining a sum of the separated water mass flow rate 606 and the condensed water mass flow rate 714. In some examples, the process 700 may also determine the water mass flow rate at the anode outlet of the galvanic pile based on the permeate water mass flow rate 604, the circulating water mass flow rate 614 and the condensed water mass flow rate 714, and then determine the total separated water mass flow rate 716 based on the water mass flow rate at the anode outlet and the separation efficiency 602 of the water-gas separator.

In another aspect, similar to the process 600 shown in FIG. 6, the process 700 can determine the circulating water mass flow rate 608 at the current moment based on the separated water mass flow rate 606, the permeate water mass flow rate 604 and the circulating water mass flow rate 614 at the previous moment, and then determine the corrected water mass flow rate 612 based on the circulating water mass flow rate 608 and the water mass flow rate level 610. The corrected water mass flow rate 612 may be used to determine the separated water mass flow rate and the circulating water mass flow rate at the next moment. In this way, when the water that is captured by the water-gas separator is determined, the condensed water in the flow channel of the galvanic pile is considered, such that the determined separated water mass flow rate is more accurate, thereby being capable of more precisely controlling the opening of the drain valve.

In some examples, after the water mass flow rate captured by the water-gas separator is determined, in order to control the frequency and duration of opening the drain valve, the amount of water that is captured by the water-gas separator over a period of time may be determined based on the separated water mass flow rate that is captured by the water-gas separator. At least one of the frequencies and duration of opening the drain valve may then be determined based on the amount of water. For example, a safety threshold for the amount of water stored in the water-gas separator may be predetermined, the drain valve is opened when the amount of water stored in the water-gas separator exceeds the safety threshold, and the duration of opening is determined based on the water mass flow rate flowing to the exhaust device after the drain valve is opened. In this way, the frequency and duration of opening the drain valve are capable of being more accurately controlled, thereby being capable of improving the safety and performance of the fuel cell system.

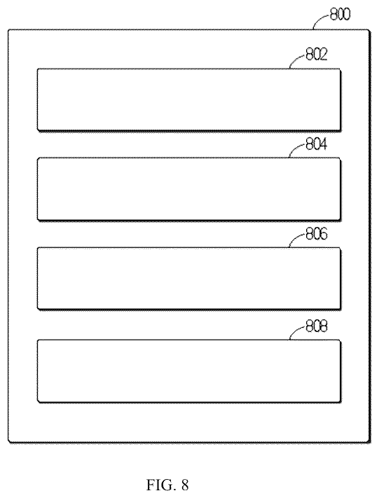

FIG. 8 shows a block diagram of a device 800 of controlling the drain valve in the fuel cell system according to some examples of the present disclosure. As shown in FIG. 8, the device 800 comprises a permeate water flow rate acquiring unit 802 configured to acquire a permeate water mass flow rate from a cathode to an anode of the fuel cell system and a separation efficiency of a water-gas separator in the fuel cell system. The device 800 further comprises a circulating water level determining unit 804 configured to determine a water mass flow rate level of water passing through a hydrogen circulating pump based on a drive current of the hydrogen circulating pump in the fuel cell system. The device 800 further comprises a circulating water flow rate determining unit 806 configured to determine a circulating water mass flow rate passing through the hydrogen circulating pump based on the permeate water mass flow rate, the separation efficiency, and the water mass flow rate level. In addition, the device 800 further comprises a drain valve control unit 808 configured to control the drain valve in the fuel cell system based on the circulating water mass flow rate.

In some examples, the circulating water level determining unit 804 is further configured to determine values indicative of an upward offset and oscillation of the drive current based on the drive current, drive voltage, reference voltage and rotating speed of the hydrogen circulating pump, and the current of the galvanic pile. The circulating water level determining unit 804 is further configured to determine the water mass flow rate level of water passing through the hydrogen circulating pump based on the values indicative of the upward offset and oscillation of the drive current.

In some examples, the circulating water level determining unit 804 is further configured to determine a reference value associated with the drive current based on the rotating speed of the hydrogen circulating pump and the current of the galvanic pile. The circulating water level determining unit 804 is further configured to determine a value indicative of the upward offset and oscillation of the drive current based on the drive current and the reference value.

In some examples, the circulating water flow rate determining unit 806 is further configured to acquire a historical circulating water mass flow rate passing through the hydrogen circulating pump at a first moment. The circulating water flow rate determining unit 806 is further configured to determine a first water mass flow rate based on the permeate water mass flow rate and the historical circulating water mass flow rate. The circulating water flow rate determining unit 806 is further configured to determine the circulating water mass flow rate based on the first water mass flow rate, the separation efficiency, and the water mass flow rate level.

In some examples, the circulating water flow rate determining unit 806 is further configured to determine a circulating water mass flow rate to be corrected based on the first water mass flow rate and the separation efficiency. The circulating water flow rate determining unit 806 is further configured to determine the circulating water mass flow rate based on the circulating water mass flow rate and the water mass flow rate level to be corrected.

In some examples, the circulating water flow rate determining unit 806 is further configured to acquire a mapping relationship between a plurality of water mass flow rate levels and a plurality of correction parameters. The circulating water flow rate determining unit 806 is further configured to determine a correction parameter corresponding to the water mass flow rate level in the plurality of correction parameters based on the water mass flow rate level and the mapping relationship. The circulating water flow rate determining unit 806 is further configured to determine the circulating water mass flow rate based on the circulating water mass flow rate to be corrected and the correction parameter.

In some examples, the permeate water mass flow rate is the first permeate water mass flow rate, the separation efficiency is the first separation efficiency, and the drain valve control unit 808 is further configured to acquire a second permeate water mass flow rate from the cathode to the anode of the fuel cell system at a second moment and a second separation efficiency of the water-gas separator. The drain valve control unit 808 is further configured to determine a separated water mass flow rate separated by the water-gas separator based on the circulating water mass flow rate, the second permeate water mass flow rate and the second separation efficiency. The drain valve control unit 808 is further configured to control the drain valve in the fuel cell system based on the separated water mass flow rate.

In some examples, the drain valve control unit 808 is further configured to determine a second water mass flow rate based on the second permeate water mass flow rate and the circulating water mass flow rate. The drain valve control unit 808 is further configured to determine the separated water mass flow rate based on the second water mass flow rate and the second separation efficiency.

In some examples, the drain valve control unit 808 is further configured to determine the condensed water mass flow rate in the flow channel of the galvanic pile in the fuel cell system. The drain valve control unit 808 is further configured to determine the separated water mass flow rate based on the second water mass flow rate and the condensed water mass flow rate.

In some examples, the drain valve control unit 808 is further configured to determine an amount of water separated by the water-gas separator over a period of time based on the separated water mass flow rate separated by the water-gas separator. The drain valve control unit 808 is further configured to determine at least one of the frequencies and duration of opening the drain valve based on the amount of water.

It will be understood that by utilizing the device 800 of the present disclosure, at least one of a number of advantages that are capable of being implemented by the method or process as described above can be implemented. For example, the frequency and duration of opening the drain valve are capable of being more accurately controlled by the device 800, thereby being capable of improving the safety and performance of the fuel cell system.

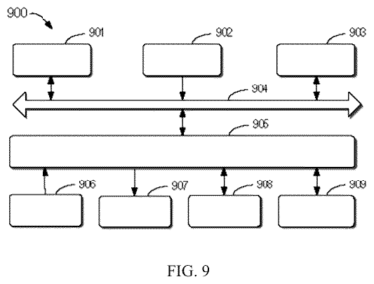

FIG. 9 illustrates a schematic block diagram of an exemplary apparatus 900 that may be used to perform the examples of the present disclosure. A controller for implementing the examples of the present disclosure may be, for example, the apparatus 900. As shown, the apparatus 900 comprises a computing unit 901 that may perform various appropriate actions and processes according to computer program instructions stored in a read only memory (ROM) 902 or computer program instructions loaded from a storage unit 908 into a random access memory (RAM) 903. Various programs and data required for the operation of the apparatus 900 may also be stored in the RAM 903. The computing unit 901, the ROM 902 and the RAM 903 are connected to each other by a bus 904. An input/output (I/O) interface 905 is also connected to the bus 904.

A plurality of components in the apparatus 900 are connected to the I/O interface 905, comprising: an input unit 906, such as a keyboard, mouse, etc.; an output unit 907, such as various types of display, speaker, etc.; a storage unit 908, such as a disk, optical disc, etc.; as well as a communication unit 909, such as a network interface card, modem, wireless communication transceiver, etc. The communication unit 909 allows the apparatus 900 to exchange information/data with other apparatuses through computer networks such as the Internet and/or various telecommunication networks.

The computing unit 901 may be various general and/or specialized processing components having processing and computing capabilities. Some examples of the computing unit 901 include, but are not limited to, the central processing unit (CPU), graphics processing unit (GPU), various specialized artificial intelligence (AI) computing chips, various computing units running machine learning model algorithms, digital signal processors (DSPs), and any appropriate processor, controller, microcontroller, etc. The computing unit 901 performs various methods and processes described above, such as the method 200. For example, in some examples, the method 200 may be implemented as a computer software program that is tangibly contained in a machine-readable medium, such as the storage unit 908. In some examples, part or all of the computer programs may be loaded and/or installed onto the apparatus 900 through the ROM 902 and/or the communication unit 909. When the computer program is loaded onto the RAM 903 and executed by the CPU 901, one or more steps of the method 200 described above may be performed. Alternatively, in other examples, the computing unit 901 may be configured to perform the method 200 by any other appropriate way (e.g., by way of firmware).

The functions described above herein may be performed at least partially by one or more hardware logic components. For example, without limitation, demonstration types of hardware logic components that may be used comprise: field programmable gate array (FPGA), application specific integrated circuit (ASIC), application specific standard product (ASSP), system on chip system (SOC), loading programmable logic device (CPLD), etc.

The program code used to implement the method of the present disclosure may be written using any combination of one or more programming languages. These program codes may be provided to a processor or controller of a general purpose computer, a special purpose computing machine or other programmable data processing devices, such that the program code, when executed by the processor or controller, causes the functions/operations specified in the flowchart and/or block diagram to be implemented. The program codes may be executed entirely on a machine, partially on the machine, partially on the machine as a standalone software package, and partially on a remote machine, or wholly on the remote machine or server.

In the context of the present disclosure, the machine-readable medium may be a tangible medium that may include or be stored for use by an instruction execution system, device, or apparatus, or a program used in combination with the instruction execution system, device, or apparatus. The machine-readable medium may be a machine-readable signal medium or a machine-readable storage medium. The machine-readable medium may include, but is not limited to, an electronic, magnetic, optical, electromagnetic, infrared, or semiconductor system, device, or apparatus, or any suitable combination described above. More specific examples of the machine-readable storage medium include electrical connections based on one or more wires, portable computer disks, hard disks, random access storage (RAM), read only memory (ROM), erasable programmable read only memory (EPROM or flash memory), optical fiber, convenient compact disk read only memory (CD-ROM), optical storage devices, magnetic storage devices, or any suitable combination described above. Further, although various operations are depicted in a particular order, this should be understood as requiring that such operations be performed in the particular order shown or in the order shown, or that all of the illustrated operations should be performed to achieve the desired result. Multiple task and parallel processing may be advantageous in a given environment. Likewise, although several specific implementation details are included in the above discussion, these should not be construed as limiting the scope of the present disclosure. Some features described in the context of separate examples may also be implemented in a single implementation in combination. Conversely, various features described in a single implemented context may also be implemented in a plurality of implementations individually or in any suitable sub-combination.

Although the present subject matter has been described in languages that are specific to structural features and/or method logical actions, it should be understood that the subject matter defined in the appended claims is not necessarily limited to the particular features or actions described above. Rather, the particular features and actions described above are merely example forms of implementing the claims.

What is claimed is:

1. A method of controlling a drain valve in a fuel cell system, comprising:
acquiring a permeate water mass flow rate from a cathode to an anode of the fuel cell system and a separation efficiency of a water-gas separator in the fuel cell system;
determining a water mass flow rate level of water passing through a hydrogen circulating pump based on a drive current of the hydrogen circulating pump in the fuel cell system;
determining a circulating water mass flow rate passing through the hydrogen circulating pump based on the permeate water mass flow rate, the separation efficiency, and the water mass flow rate level; and
controlling the drain valve in the fuel cell system based on the circulating water mass flow rate.

2. The method of claim 1, wherein determining the water mass flow rate level of water passing through the hydrogen circulating pump comprises:
determining values indicative of an upward offset and an oscillation of the drive current based on the drive current, drive voltage, reference voltage, rotating speed of the hydrogen circulating pump and a current of a galvanic pile; and
determining the water mass flow rate level of the water passing through the hydrogen circulating pump based on the values indicative of the upward offset and the oscillation of the drive current.

3. The method of claim 2, wherein determining the values indicative of the upward offset and the oscillation of the drive current comprises:
determining a reference value associated with the drive current based on the rotating speed of the hydrogen circulating pump and the current of the galvanic pile; and
determining the values indicative of the upward offset and the oscillation of the drive current based on the drive current and the reference value.

4. The method of claim 1, wherein determining the circulating water mass flow rate passing through the hydrogen circulating pump comprises:
acquiring a historical circulating water mass flow rate passing through the hydrogen circulating pump at a first moment;
determining a first water mass flow rate based on the permeate water mass flow rate and the historical circulating water mass flow rate; and
determining the circulating water mass flow rate based on the first water mass flow rate, the separation efficiency, and the water mass flow rate level.

5. The method of claim 4, wherein determining the circulating water mass flow rate comprises:
determining a circulating water mass flow rate to be corrected based on the first water mass flow rate and the separation efficiency; and
determining the circulating water mass flow rate based on the circulating water mass flow rate to be corrected and the water mass flow rate level.

6. The method of claim 5, wherein determining the circulating water mass flow rate comprises:
acquiring a mapping relationship between a plurality of water mass flow rate levels and a plurality of correction parameters;
determining a correction parameter corresponding to the water mass flow rate level in the plurality of correction parameters based on the water mass flow rate level and the mapping relationship; and
determining the circulating water mass flow rate based on the circulating water mass flow rate to be corrected and the correction parameter.

7. The method of claim 1, wherein the permeate water mass flow rate is a first permeate water mass flow rate, the separation efficiency is a first separation efficiency, and controlling the drain valve in the fuel cell system further comprises:
acquiring a second permeate water mass flow rate from the cathode to the anode of the fuel cell system and a second separation efficiency of the water-gas separator at a second moment; and
determining a separated water mass flow rate separated by the water-gas separator based on the circulating water mass flow rate, the second permeate water mass flow rate and the second separation efficiency; and controlling the drain valve in the fuel cell system based on the separated water mass flow rate.

8. The method of claim 7, wherein determining the separated water mass flow rate separated by the water-gas separator comprises:
determining a second water mass flow rate based on the second permeate water mass flow rate and the circulating water mass flow rate; and
determining the separated water mass flow rate based on the second water mass flow rate and the second separation efficiency.

9. The method of claim 8, wherein determining the separated water mass flow rate further comprises:
determining a condensed water mass flow rate in a galvanic pile flow channel of the fuel cell system; and
determining the separated water mass flow rate based on the second water mass flow rate and the condensed water mass flow rate.

10. The method of claim 1, wherein controlling the drain valve in the fuel cell system comprises:
determining an amount of water separated by the water-gas separator within a period of time based on the separated water mass flow rate separated by the water-gas separator; and
determining at least one of a frequency and duration of opening the drain valve based on the amount of water.

11. A device of controlling a drain valve in a fuel cell system, comprising:
a permeate water flow rate acquiring unit configured to acquire a permeate water mass flow rate from a cathode to an anode of the fuel cell system and a separation efficiency of a water-gas separator in the fuel cell system;
a circulating water level determining unit configured to determine a water mass flow rate level of water passing through a hydrogen circulating pump based on a drive current of the hydrogen circulating pump in the fuel cell system;
a circulating water flow rate determining unit configured to determine a circulating water mass flow rate passing through the hydrogen circulating pump based on the permeate water mass flow rate, the separation efficiency, and the water mass flow rate level; and
a drain valve control unit configured to control the drain valve in the fuel cell system based on the circulating water mass flow rate.

12. A controller, comprising:
at least one processor; and
a memory coupled to the at least one processor and having instructions stored thereon, the instructions, when executed by the at least one controller, causing the controller to perform the method according to claim 1.

13. A fuel cell system, comprising:
a galvanic pile;
a water-gas separator located in a first channel connected to an anode outlet of the galvanic pile;
a drain valve located in a second channel connected to the water-gas separator;
a hydrogen circulating pump located in a third channel connected to an anode inlet of the galvanic pile; and
a controller according to claim 12.

14. A computer-readable storage medium having computer-executable instructions stored thereon, wherein the computer-executable instructions are executed by the processor to implement the method according to claim 1.
